(19) United States
(12) Patent Application Publication
(10) Pub. No.: US 2014/0244535 A1
(43) Pub. Date: Aug. 28, 2014

(54) TRACKING SYSTEM FOR FOOD DONATION PROGRAMS

(71) Applicant: FOOD DONATION CONNECTION, LLC, Knoxville, TN (US)

(72) Inventor: Larry Costigan, Knoxville, TN (US)

(73) Assignee: FOOD DONATION CONNECTION, LLC, Knoxville, TN (US)

(21) Appl. No.: 13/780,424

(22) Filed: Feb. 28, 2013

(51) Int. Cl. G06Q 10/08

(52) U.S. Cl. CPC G06Q 10/0833
USPC 705/329

(57) ABSTRACT

A food donation tracking system is provided for tracking food donations along a food donation route that includes a food recipient location and a plurality of food rescue locations. The system includes a display device at each of the food rescue locations, each display device being operable to generate a dynamic unique code specific to the food rescue location where the display device is located. A driver scans the dynamic unique code with a handheld unit. Tracking information is recorded and transmitted from the handheld unit to a central server. The tracking information includes location information identifying the food rescue location of the food donation pickup based on the dynamic unique code scanned at the food rescue location and time information corresponding to when the unique code was scanned at the food rescue location.

### FIELD

This disclosure relates to the field of food donation programs. More particularly, this disclosure relates to a cost effective and efficient central monitoring system for tracking donated food conditions between food rescue locations and food recipient locations.

### BACKGROUND

According to a 2012 report from the National Resources Defense Counsel, about 40% of food produced in the United States is never eaten. Included in this number is perfectly edible food thrown out by food providers such as restaurants because the food may have passed the point of restaurant quality or may not be selling as well as projected. Food donation programs are designed to collect this unwanted food to feed the hungry and those less fortunate. Accordingly, such programs are an important tool in fighting hunger as they make use of edible food that otherwise would be discarded.

As many of the food items that are donated in food donation programs have relatively short expiration dates, care must be taken during the food donation process to ensure these items remain in an edible quality. Particular care should be exercised in the case of food such as meat, poultry, eggs, and dairy products as these items are potentially hazardous if consumed after expiration or when handled improperly. In order to preserve the quality of food items, certain precautions should taken by those handling the food. In particular, the food's temperature, storage times, and other handling conditions should be properly managed during the food donation process.

The food donation process typically includes food rescue locations (i.e., the location of the restaurant or food provider that is donating the food), one or more food recipient locations (i.e., locations where the donated food from food rescue locations is collected such as a food bank), and drivers that pick up the donated food from the food rescue locations and deliver the food to one of the food recipient locations. As the food recipient locations are typically a charity or non-profit organization, the food rescue locations and drivers are typically volunteers in the food donation process. Thus, it is desirable to make the food donation process as easy and efficient as possible in order to entice food rescue locations and drivers to volunteer in the food donation program of the food recipient location. However, the food recipient location must still be extremely diligent in making sure the conditions in which the donated food was handled were proper before accepting the donated food.

Handling of the donated food begins at the food rescue location. Preferably, the food rescue location will document the handling conditions of the donated food. Such conditions include when the food was initially prepared, whether the items have been stored in a frozen or thawed condition, and/or the temperature and time in which the items have been refrigerated. The driver then picks up the donated food from the food rescue location and delivers the food to the food recipient location. The food recipient location determines whether to accept/use the donated food from the food rescue location. Thus, the more information regarding the handling conditions of the donated food the food recipient location has at its disposal, the easier it is to determine whether the food is of edible quality and/or when the food will likely expire. However, the food recipient location often has very little information regarding the conditions of the donated food during transportation to the food recipient location and any information it does have is manually monitored and recorded individually by each driver. Thus, the information is dependent on the driver keeping accurate and complete records while driving to and from the food rescue locations.

Accordingly, a food donation system is needed to accurately and efficiently monitor and record conditions of the donated food during transportation to ensure items are safe for future consumption. In particular, a system is needed to track donated food conditions from a food rescue location to a food recipient location including the period of time in which the donated food was in transport.

### SUMMARY

A method is disclosed for tracking food donations along a food donation route that includes a food recipient location and a food rescue location. The method includes providing a display device at the food rescue location; generating a unique code specific to the food rescue location; displaying on the display device the unique code; scanning with a handheld unit the unique code when a driver picks up donated food from the food rescue location; and transmitting tracking information corresponding to the donated food from the handheld unit to a central computer system, the tracking information including location information identifying the food rescue location based on the unique code and time information corresponding to when the driver scanned the unique code at the food rescue location.

According to some embodiments, the method further includes taking a temperature of the donated food with the handheld unit at the food rescue location and transmitting temperature information from the handheld unit to the central computer system, the temperature information including the temperature of the donated food at the food rescue location.

In certain embodiments, the unique code generated by the display device is a dynamic unique code that changes over time. Further, the dynamic unique code is generated using an algorithm saved locally to the display device, and the method further includes transmitting the dynamic unique code to the central computer system as part of the tracking information to be matched by the central computer system for determining the location information and time information. The central computer system has access to the algorithm and the method further includes matching the dynamic unique code scanned with the handheld unit and the time information to determine accuracy of the tracking information at the central computer system. According to certain embodiments, the dynamic unique code transmitted to the central computer system is encrypted, and the method further includes translating the encrypted dynamic unique code at the central computer system for matching the dynamic unique code.

According to some embodiments, the handheld unit is a smartphone and the unique code is a two-dimensional barcode.

According to another embodiment of the disclosure, a method for tracking food donations along a food donation route that includes a food recipient location and a plurality of food rescue locations includes: providing a display device at each of the food rescue locations, each display device operable to generate a dynamic unique code specific to the food rescue location where the display device is located that changes over time; displaying on each display device the dynamic unique code; driving to a first food rescue location among the plurality of food rescue locations to perform a first food donation pickup; scanning with a handheld unit the dynamic unique code of the display device of the first food rescue location during the first food donation pickup; driving to the remaining plurality of food rescue locations on the route and repeating steps (c) and (d) that were performed at the first food rescue location to thereby perform a food donation pickup at each of the plurality of food rescue locations; recording in the handheld unit tracking information corresponding to each food donation pickup, the tracking information of each food donation pickup including location information identifying the food rescue location of the food donation pickup based on the dynamic unique code scanned at the food rescue location and time information corresponding to when the unique code was scanned at the food rescue location; and connecting the handheld unit to a server and transferring the tracking information to the server.

### BRIEF DESCRIPTION OF THE DRAWINGS

Further advantages of the disclosure are apparent by reference to the detailed description in conjunction with the figures, wherein elements are not to scale so as to more clearly show the details, wherein like reference numbers indicate like elements throughout the several views, and wherein:

FIG. 1 depicts a schematic diagram of a food donation tracking system according to one embodiment of the disclosure;

FIGS. 2A-2B depict components and interaction of a handheld unit and central server according to one embodiment of the disclosure; and

FIG. 3 depicts a display of a display device according to one embodiment of the disclosure.

### DETAILED DESCRIPTION

The disclosure relates to a tracking system for monitoring activities of individuals and securely recording time and location data of events within a global network. In particular, a food donation tracking system is disclosed for monitoring and recording the time and conditions in which donated food is delivered from food donation locations to a food recipient location to reinforce policies established to ensure that the donated food being delivered is safe for later consumption. While the tracking system is specifically described below in the form of a food donation tracking system, it should be recognized that the features of this system have applicability in other industries in which tracking and timekeeping for employees, drivers, service workers, patrolling guards, etc. is needed or helpful.

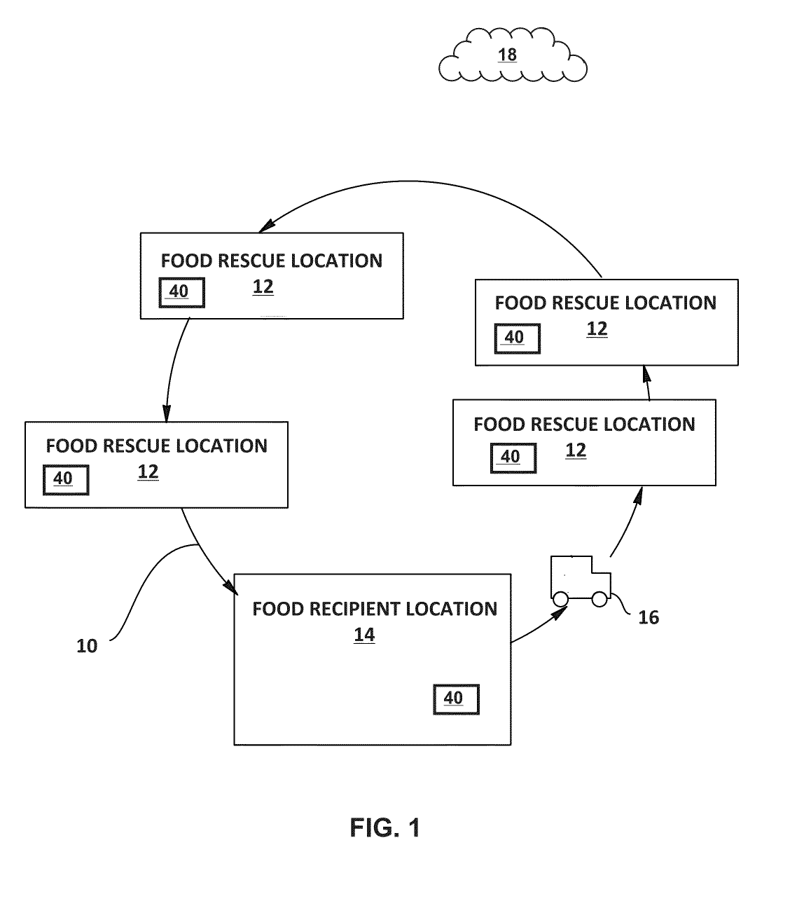

Referring to FIG. 1, a food donation tracking system/route 10 is shown having a plurality of food rescue locations 12, at least one food recipient location 14, and at least one driver/volunteer 16 that transports donated food from one or more of the food rescue locations 12 to the food recipient location 14. As explained above, food safety is the primary concern in food donation programs, and a major component of food safety and managing the risk that the donated food will remain safe to consume is temperature control. Thus, the food donation tracking system 10 as described below is designed to ensure that the food is transported in a safe and timely fashion by monitoring when food is picked up at a food rescue location 12 and when it arrives at the food recipient location 14.

As shown in FIG. 1, the food recipient location 14 and the food rescue locations 12 all include a code display device 40. A central server 18 is provided that is preferably cloud based and located remotely from the food recipient location 14 for receiving tracking information from the drivers 16. In some embodiments, the central server 18 is hosted and maintained by a third party with the food recipient location 14 having access to the information of the server 18 provided by the food tracking system 10.

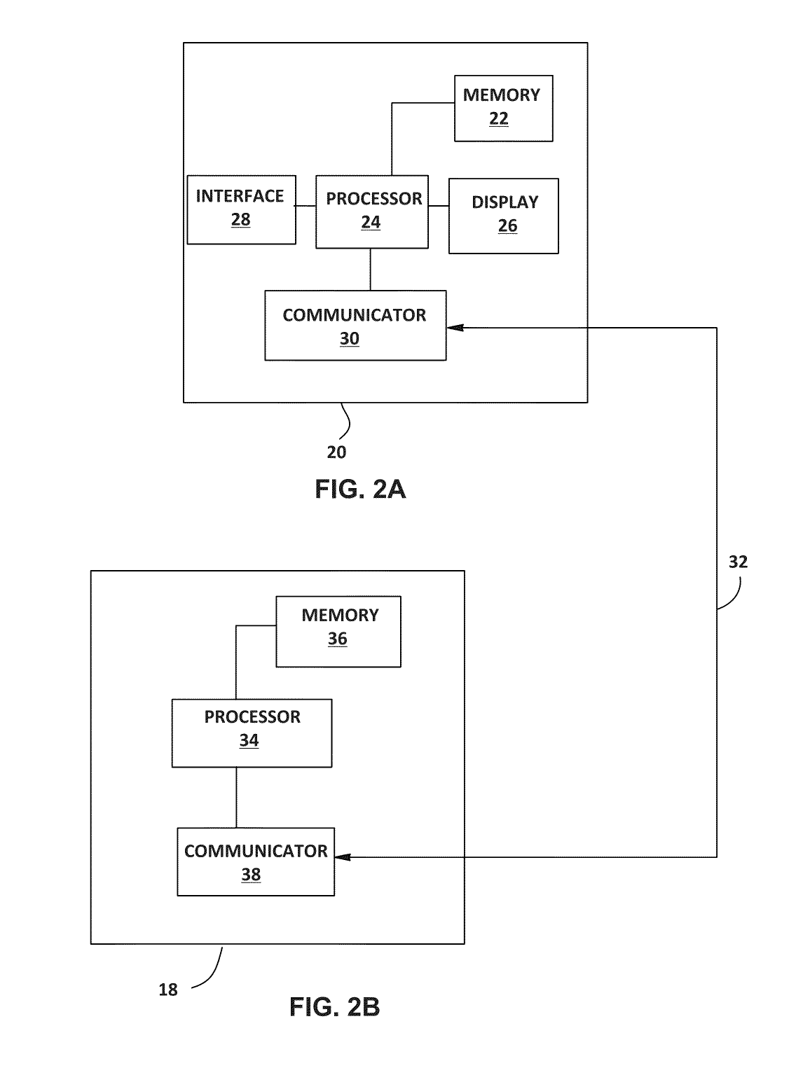

Referring to FIGS. 2A-2B, drivers 16 access the central server 18 using handheld units 20. Referring to FIG. 2A, each handheld unit 20 is a portable device having a memory 22 connected to a processor 24. The processor 24 is connected to a display 26 for displaying information to the driver 16. The processor 24 is connected to a user interface 28 for receiving input from the driver 16. Each driver 16 is given a unique id and is able to log in to the user interface 28 for accessing the food donation tracking system 10 and transmitting information relating for that particular driver 16 to the server 18. The processor 24 also includes a communicator 30 that is operable to transmit and receive information from the central server 18 through connection 32. The connection 32 may be a wireless and/or a hard-wired connection. Preferably, the communicator 30 provides wireless access to the server 18 through a wireless communication such as a cellular, Bluetooth, or wireless Internet connection. Referring to FIG. 2B, the server 18 includes a processor 34 connected to a memory 36. The processor 34 is also connected to a communicator 38 which is capable of transmitting and receiving information from the communicator 30 of the handheld unit 20 through connection 32. The processor 34 of server 18 is capable of communicating with multiple handheld units 20 simultaneously.

In preferred embodiments, the handheld unit 20 is a smartphone and the user interface 28 is part of a specific software application downloaded to the smartphone device for communication with server 18. Alternatively, the handheld unit 20 may be a device designed specifically for use with the food donation tracking system 10 of the present disclosure.

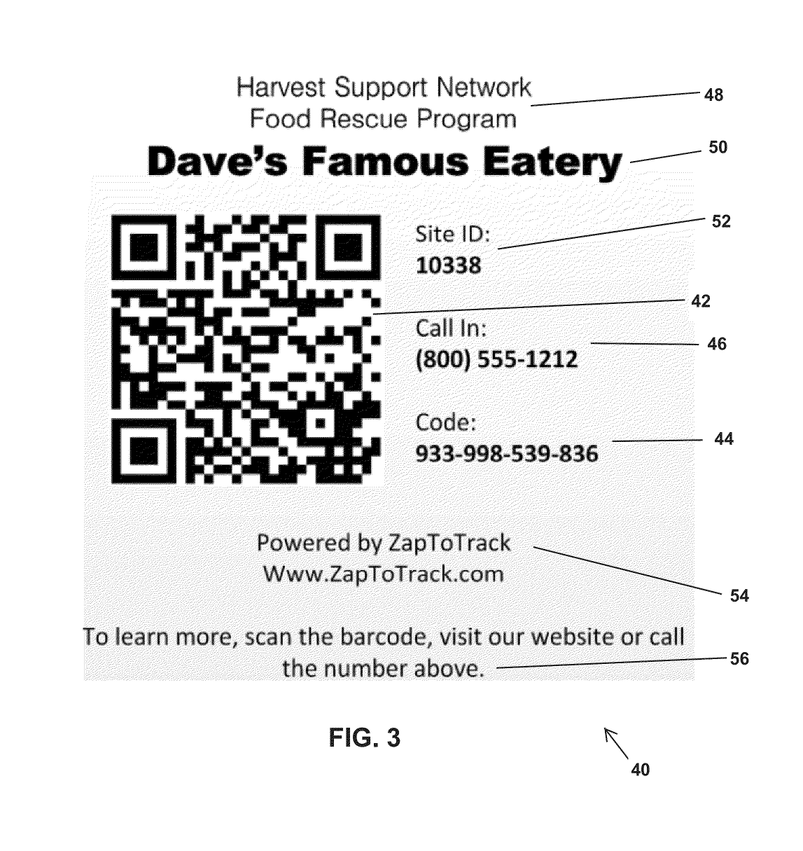

Referring to FIG. 3, each of the food rescue locations 12 includes a display device 40 that displays a unique code 42 that is specific to the particular food rescue location 12 that the display device 40 is located for that particular point in time. The unique code 42 may be any type of code that is able to be scanned by the handheld unit. As shown, the unique code 42 is preferably a two dimensional Quick Response (“QR”) code. When the driver 16 arrives at a food rescue location 12 to pick up donated food, the driver scans the unique code 42 with their handheld unit 20. The handheld unit 20 generates tracking information based on the scan that is transmitted to the central server 18. Alternatively, as explained further below, the driver 16 may use a standard phone to call into an automated server process and enter a dynamically generated numerical identification code 44 displayed on the display device, which will communicate the same information to the server 18 as the scanned code 42. The tracking information includes an identification of the driver/user and location information determined based on an identification of the unique code 42 that was scanned and a time stamp of when the driver 16 picked up the donated food. Thus, the location of the driver 16 is able to be determined by the central server 18 based on when the driver 16 scanned the unique code 42 of a particular food rescue location 12 as the display device 40 of each food rescue location displays a unique code 42 that is specific to the particular food rescue location 12. It is noted that, unlike many other present tracking systems known in the art, the tracking information described above is able to be determined without requiring any Global Positioning Satellite (GPS) capabilities.

The tracking information is then transmitted from the handheld unit to the central server 18 anytime during the food donation route. Preferably, the tracking information is submitted to the central server 18 soon after each scan of a unique code 42. However, the tracking information may also be cached in the memory 22 of the handheld unit 20 for later submission to the central server. For example, a food rescue location 12 may be out of cellular range such that the handheld unit 20 is unable to communicate with the central server 18. In these cases, the tracking information is saved to the memory 22 of the handheld unit 20 and submitted once the handheld unit 20 is able to receive a cellular signal. To provide additional security, the tracking information is preferably transmitted to the central server 18 in an encrypted fashion, and the central server 18 translates the encrypted code to determine the unique display device (and therefore the location of the driver 16), and the time in which the code was scanned.

Similar to the food rescue locations 12, the food recipient location 14 also includes a display device 40. Thus, the driver 16 will scan a unique code 42 specific to the food recipient location 14 with the handheld unit when the driver 16 delivers the donated food picked up from the food rescue locations 12 to the food recipient location 14. The handheld unit 20 then generates tracking information based on the scan at the food recipient location 14 that is also transmitted to the central server 18. Based on the tracking information gathered from the code scans at each of the food rescue locations 12 and the code scan at the food recipient location 14, the server 18 is able to determine how long the donated food from each of the food rescue locations 12 was in transport until it arrived at the food recipient location 14. This information is used to track delivery times to help determine whether the donated food was transported in a safe and timely fashion such that it is safe for later consumption.

In another aspect of the disclosure, the unique codes 42 displayed by the display devices 40 are preferably changed over a period of time to prevent fraud and the obtaining of unauthorized information by the server 18. By using a dynamic as opposed to static unique code 42, the server 18 is able to determine the accuracy of the tracking information by matching the unique code with the time stamp of when the driver 16 scanned the unique code 42 with the handheld unit 20. If the unique code 42 does not match the particular code that was scheduled to be displayed on the display device 40 at that particular time, the server 18 is able to determine that the system 10 has been manipulated, exploited, or the accuracy of the tracking information is otherwise in doubt.

Preferably, the display devices 40 dynamically generate the unique codes 42 based on mathematical algorithms integrated into the design of the display devices 40. The unique codes 42 could be changed on a specific schedule based on the needs of the individual location. The algorithms are also stored at the server 18 such that the server 18 will be able to determine that the scanned unique code 42 matches the code that should have been displayed on the display device 40 at that location at that particular time. Further, the tracking information gathered by the system 10 when the drivers 16 scan the unique codes 42 is transmitted to the server from the handheld units 20. Thus, the display devices 40 do not need any communication capabilities making them able to be affordably constructed and deployable without need for networking or cellular access. In alternate embodiments, the display devices 40 are operable to communicate with the server 18 such that tracking information may be transmitted from the display devices 40 to the server 18 when a handheld unit 20 scans a unique code 42.

As mentioned above, for cases in which the driver 16 does not have a handheld unit 20 that is capable of scanning the unique code 42, the display device 40 also preferably includes a numerical identification code 44 that is also specific to the food rescue location 12. When picking up the donated food, the driver 16 may then call a phone number 46 and enter the numerical identification code 44 into an interactive voice response or touch tone system for submitting the tracking information to the central server 18. Like the unique code 42, the numerical identification code 44 is also preferably dynamically generated by the display device 40.

In situations in which a handheld unit of a person that is not registered with the program scans the unique code 42 (e.g., a person's smartphone includes a generic QR code reader but does not include the software application specific to the food donation tracking system 10), the handheld unit 20 is linked to a webpage that displays marketing information for the food rescue location such as menus, coupons, marketing videos, etc. The use of the display device as a marketing tool for the food rescue locations 12 can serve as incentive to be involved in the food donation tracking system. Additionally, the marketing information could be directed to or include a link to information regarding the food donation tracking system such as an explanation of the donation program, information regarding how to become a volunteer in the program, and a link to register/download the system application.

Referring to FIG. 3, the display device 40 may also display additional information such as an identification of the food recipient location or food donation program operator 48, an identification of the particular food rescue location 50 in which the display device 40 is located, a site identification number 52 identifying the food rescue location 12, identification of the operator of the food donation tracking system 54, and instructions 56 on how to use the display device 40.

In addition to transmitting tracking information to the central server 18, other information regarding the condition of the donated food may be obtained by the driver 16 at the food rescue locations 12 and the food recipient location 14 to provide additional information for determining the expiration of the donated food. Such food condition information may include, for example, a temperature reading of the donated food and photographical representations of the donated food. For example, the handheld unit 20 may be equipped with an infrared sensor or attachable thermometer that may be used to take the temperature of donated food at the time the driver 16 picks up the food at a food rescue location 12 and when the driver 16 drops the food off at the food recipient location 14. Additionally, the handheld unit 20 may include a camera for taking a photograph of the food. The food condition information is then transmitted to the central server 18 along with the tracking information for assisting the food recipient location 14 in determining the condition of the donated food.

While the server 18 receives tracking and food condition information from each handheld unit 20, the server 18 is also preferably able to push information to the driver 16. For example, the driver 16 may use the handheld unit 20 to find nearby food rescue locations 12 or food recipient locations 14, or look up the time in which donated food was picked up from certain food rescue locations 12. The server may also send messages to the driver 16 such as warning messages indicating that donated food has been in transport for a particular time and needs to be dropped off immediately at the food recipient location 12.

In another aspect of the disclosure, each food rescue location 12 may submit condition information of the donated food for submission to the central server 18. The information may be submitted through a handheld unit running the software application similar to the handheld unit 20 used by the drivers, or it could be submitted by a computer system located at the food rescue location 12. Alternatively, the condition information could be stored/entered onto the display device 40 and gathered by a driver 16 when the driver picks up donated food from the food rescue location 12. Such condition information could include a description of the type and amount of food being donated, the age of the food, the condition in which the food has been stored (i.e., hot, frozen or refrigerated), temperature readings, pictures, and/or when the donated food is available for pick-up by a driver 16.

The foregoing description of preferred embodiments for this disclosure have been presented for purposes of illustration and description. They are not intended to be exhaustive or to limit the disclosure to the precise form disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

1. A method for tracking food donations along a food donation route that includes a food recipient location and a food rescue location, the method comprising:
providing a display device at the food rescue location;
generating a unique code specific to the food rescue location;
displaying on the display device the unique code;
scanning with a handheld unit the unique code when a driver picks up donated food from the food rescue location; and
transmitting tracking information corresponding to the donated food from the handheld unit to a central computer system, the tracking information including location information identifying the food rescue location based on the unique code and time information corresponding to when the driver scanned the unique code at the food rescue location.

2. The method of claim 1 further comprising:
taking a temperature of the donated food with the handheld unit at the food rescue location; and
transmitting temperature information from the handheld unit to the central computer system, the temperature information including the temperature of the donated food at the food rescue location.

3. The method of claim 1 wherein the unique code generated by the display device is a dynamic unique code that changes over time.

4. The method of claim 3 wherein the dynamic unique code is generated using an algorithm saved locally to the display device, the method further comprising transmitting the dynamic unique code to the central computer system as part of the tracking information to be matched by the central computer system for determining the location information and time information.

5. The method of claim 4 wherein the display device has no communication capabilities.

6. The method of claim 4 wherein the central computer system has access to the algorithm, the method further comprising matching the dynamic unique code scanned with the handheld unit and the time information to determine accuracy of the tracking information at the central computer system.

7. The method of claim 6 wherein the dynamic unique code transmitted to the central computer system is encrypted, the method further comprising translating the encrypted dynamic unique code at the central computer system for matching the dynamic unique code.

8. The method of claim 1 wherein the handheld unit is a smartphone.

9. The method of claim 1 wherein the unique code is a two-dimensional barcode.

10. A method for tracking food donations along a food donation route that includes a food recipient location and a plurality of food rescue locations, the method comprising:
(a) providing a display device at each of the food rescue locations, each display device operable to generate a dynamic unique code specific to the food rescue location where the display device is located that changes over time;
(b) displaying on each display device the dynamic unique code;
(c) driving to a first food rescue location among the plurality of food rescue locations to perform a first food donation pickup;
(d) scanning with a handheld unit the dynamic unique code of the display device of the first food rescue location during the first food donation pickup;
(e) driving to the remaining plurality of food rescue locations on the route and repeating steps (c) and (d) that were performed at the first food rescue location to thereby perform a food donation pickup at each of the plurality of food rescue locations;
(f) recording in the handheld unit tracking information corresponding to each food donation pickup, the tracking information of each food donation pickup including location information identifying the food rescue location of the food donation pickup based on the dynamic unique code scanned at the food rescue location and time information corresponding to when the unique code was scanned at the food rescue location; and
(g) connecting the handheld unit to a server and transferring the tracking information to the server.

11. The method of claim 10 further comprising:
providing the food recipient location with a display device for recording when donated food is delivered to the food recipient location;
delivering to the food recipient location the donated food picked up at the plurality of food rescue locations; and
scanning the display device of the food-drop off location with the handheld unit to generate tracking information including receiving time information corresponding to when the donated food is delivered to the food recipient location.

12. The method of claim 10 further comprising:
taking a temperature of the donated food with the handheld unit at each food rescue location; and
transmitting temperature information from the handheld unit to the central computer system, the temperature information including the temperature of the donated food at each food rescue location.

13. The method of claim 10 wherein the dynamic unique code is generated using an algorithm saved locally to the display device, the method further comprising transmitting the dynamic unique code to the central computer system as part of the tracking information to be matched by the central computer system for determining the location information and time information.

14. The method of claim 10 wherein the handheld unit is a smartphone.

15. The method of claim 10 wherein the unique code is a two-dimensional barcode.
